(19) United States
(12) Patent Application Publication
(10) Pub. No.: US 2004/0199413 A1
(43) Pub. Date: Oct. 7, 2004

(54) System and method for providing service for a product

(76) Inventors: Terrence A. Hauser, Mission Viejo, CA (US); Timothy L. Ford, Vista, CA (US)

Correspondence Address: FISH & RICHARDSON, PC, 12390 EL CAMINO REAL, SAN DIEGO, CA, 92130-2081, US

(21) Appl. No.: 10/408,086

(22) Filed: Apr. 3, 2003

(51) Int. Cl. G06F 17/60

(52) U.S. Cl. 705/7

(57) ABSTRACT

Methods and systems for servicing a product are disclosed. These systems and methods are particularly suited for stationary product that are immovable or permanently deployed at a customer's location, such as a spa. A system includes a terminal for receiving and processing service call information for the product, and a database for associating the service call information with a customer record to generate a service call request. The customer record includes product information and customer history. The system further includes a hand-held device configured to receive the service call request from the database. The hand held device is also configured to run interactive diagnostic routines. The system is configured to invoke one or more automatic service-related programs, such as warranty status determination, paperwork generation, parts replenishment, reporting and payment programs.

### TECHNICAL FIELD

This invention relates to data processing and communication, and more particularly to a system and method for computer processing and communication of service information for manufactured products.

### BACKGROUND

Dealers, manufacturers, or suppliers of manufactured products and their parts usually provide a service operation to handle service calls. For instance, if a customer experiences a problem with a product, the customer usually reports the problem to either the dealer or the manufacturer. The dealer or manufacturer will typically respond to the problem by sending out a service operator to the customer. The service operator may be a technician or other person who can diagnose the problem and plan for its correction.

One particular type of manufactured product that may require servicing, such as replacement or repair of failed parts, diagnostic testing and problem evaluation, is the hydrotherapy spa. Spas come in many different models, and a particular manufacturer or dealer will make and sell several different models at any given time. The manufacturer/dealer must therefore provide service for different models of spas, each having a different configuration and age, and unique service requirements.

Conventional service calls for manufactured products can be inefficient, expensive, and time-consuming, either for the customer or the manufacturer/dealer, or both. The service operator may not have complete information about the problem, such as a list of required replacement parts, a complete set of diagnostic tools, or even reliable directions to the customer's location. A service operator may also have an inefficiently planned appointment schedule or route. Similarly, the manufacturer/dealer may not receive a complete and accurate account of the work provided by the service operator, or what parts or tools to provide the service operator. These and other inefficiencies and problems can be very costly to all parties involved.

### SUMMARY

In contrast with the above, one implementation of a service system enables a complete and efficient communication of service information to the benefit of all parties to a service call. This implementation employs a database communicating information with a hand held device used by a service operator. The hand held device gathers information for representing an accurate account of the entire service operation. The methods and systems described herein are suited for servicing of spa products, but can be applied to any products, particularly products that are permanently deployed at a customer's location.

Another aspect of this implementation is a system that automatically generates the most efficient and logical service route based on any number of characteristics of a service operator's schedule, based on factors including time, geography, nature of the service calls, and product categories.

In one method for providing service for a product, service call information is associated with a customer record, where the customer record includes product information, to generate a service call request. The method further includes grouping one or more service call requests into a service route, and downloading the service route to a hand held device.

In another aspect, a system for providing service for a product includes a terminal for receiving and processing service call information, and a database for associating the service call information with a customer record, where customer record includes product information and customer history, to generate a service call request. The system also includes a hand-held device configured to receive the service call request from the database.

Another method for providing service for a product such as a spa, includes the steps of associating service call information with a customer record, where the customer record includes product information, to generate a service call request. The service call request is downloaded to a hand held device, either alone or grouped with other service call requests based on a common geography, product, of technician, etc. The method further includes a step of reporting a status of the service call request to a vendor according to the service call request, and closing the service call request with the vendor upon completion of a service call associated with the service call request.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a simplified block diagram of a service environment including a service system according to one implementation.

FIG. 2 is a block diagram of a service system according to an implementation.

FIG. 3 is a diagrammatic representation of tasks and outputs of the service system.

FIG. 4 is a flowchart illustrating a service call method by a service center.

FIG. 5 is a flowchart illustrating a service call method by a service operator.

FIGS. 6-11 are screen shots of a service center terminal for a spa manufacturer/dealer.

FIGS. 12-19 are screen shots of a hand held device used by a service operator for spa equipment.

FIGS. 20-23 are screen shots of the service center terminal after uploading information from the hand held device upon servicing spa equipment.

Like reference symbols in the various drawings indicate like elements.

### DETAILED DESCRIPTION

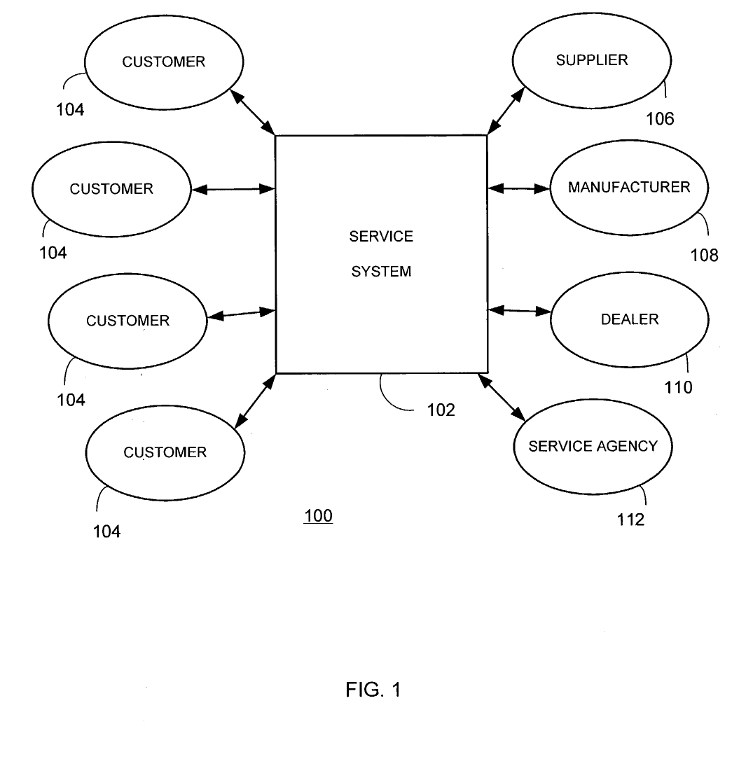

FIG. 1 is a simplified block diagram of an environment 100 for which an implementation of a service system 102 is suited. The service system 102 includes computer processing and communications components for handling customer service calls for manufactured products. As depicted in FIG. 1, the service system 102 also provides an interface between customers 104, suppliers 106, manufacturers 108, dealers 110 and service agencies 112 for the exchange of service-related information. It should be understood FIG. 1 is merely illustrative, and not to be construed as limiting the functionality and/or domain of the service system 102 in any way.

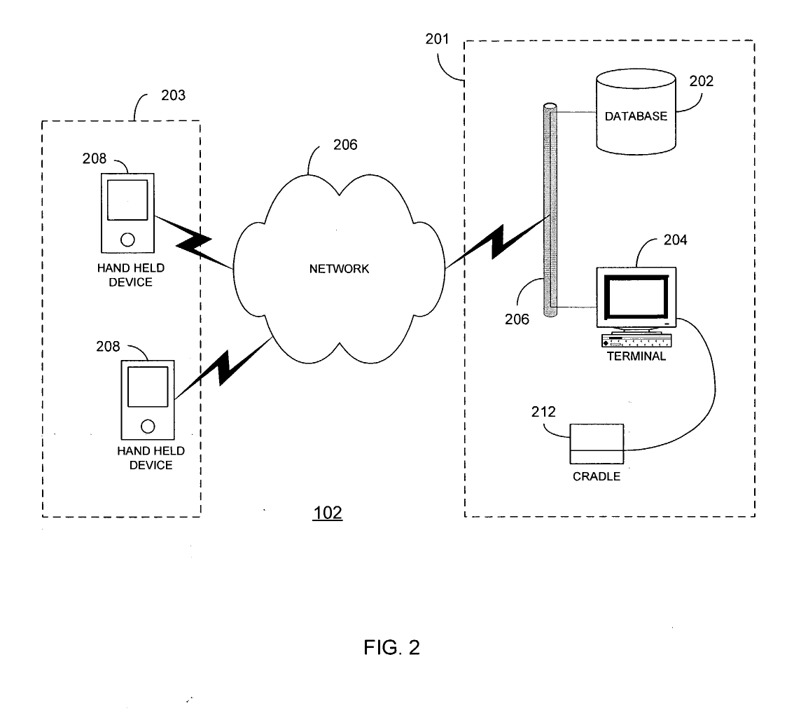

FIG. 2 is a block diagram of the basic components of one implementation of a service system 102. The service system 102 includes a service center 201, which represents a service organization, dealer, manufacturer or supplier having a service department. The service center 201 may also be part of a service agency acting as the service department of a dealer, manufacturer, or supplier of the manufactured product. The service center 201 includes a database 202 in communication with a terminal 204. The database 202 may be co-located with or remotely connected to the terminal 204. The database 202 may be a relational database that can be accessed by a system query language (SQL), or any other similar storage and query structure.

The terminal 204 communicates with one or more hand held devices 208 via a communications network 206. The terminal 204 may be a personal computer, computer workstation or other computing device with a display, such as a phone, tablet computer, hand held computing device etc., and preferably includes a web browser and Internet connectivity. The terminal 204 may include an internal central processing unit (CPU) for executing one or more software applications. For example, the terminal 204 may include software for receiving and providing data such as customer information, parts lists, product information, and diagnostic guides related to a manufactured product. The terminal 204 also may include software for generating and providing a map of a geographical area. The software may be resident on the terminal 204, or executed remotely by a server in the network 206 under instruction by the terminal 204, such as an active server page (ASP), for example.

The network 206 may be the Internet, but may also be a local area network (LAN), wide area network (WAN), or other network of interconnected communication devices. The network 206 may also include a wireless network for data and/or voice communication to and from the hand held device 208.

The hand held device 208 can be a personal digital assistant (PDA), portable or laptop personal computer (PC), wireless telephone, wireless messaging device, or any other hand-held computing device. The hand held device 208 includes a user interface for receiving user commands, a display for displaying information, and one or more inputs for receiving data. For instance, the hand held device 208 can have a number of input keys, an interactive display, or one or more scroll or navigation buttons. The hand held device 208 may even include an input for recording audio, image and/or video signals. The hand held device 208 communicates data between the terminal 204 by a wireless connection such as over the network 206 or by a physical connection such as a cradle 212 connected to the terminal 204. The one or more hand held devices 208 collectively make up a service operator 203, which in turn represents one or more service technicians using a hand held device for field service calls.

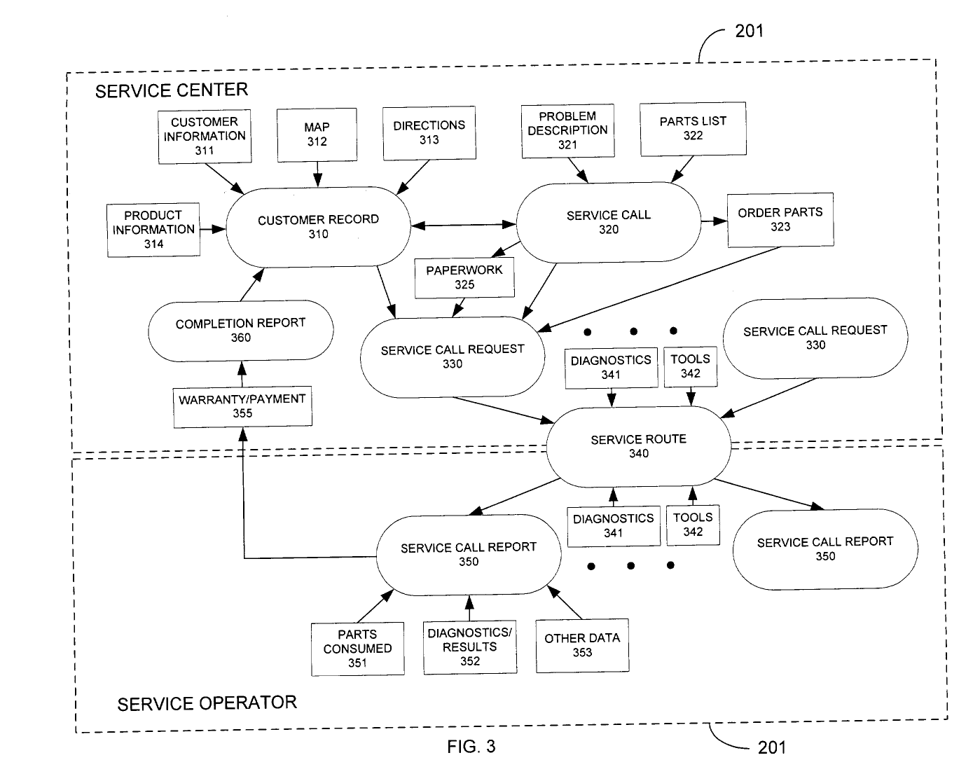

FIG. 3 further describes the functionality of the service system 102 in a diagram showing an example of the primary tasks and resultant outputs of the service center 201 and the service operator 203. It should be understood that the number and/or exact arrangement of these tasks and outputs can be varied and still fall within the scope of this description. Tasks are represented by a block and indicate a particular function, a input, or set of information. Resultant outputs are represented by an oval, and indicate a product of the functions or inputs, a processing output, or collection of information. Outputs can be based on tasks and/or other outputs, and can be provided as a form in a display including, but not limited to, an interactive text file, a graphical or image file, or a hypertext markup language (HTML) or extensible markup language (XML) file. The information provided in the forms is stored in the database 202 for access by the terminal 204.

A customer record 310 can be generated from information stored in the database 202 for each customer of a manufactured product. The customer record 310 includes customer information 311, including, without limitation, the customer's name, address, and/or phone number, etc. The customer record 310 can also be linked with a map 312 of the customer's location and directions 313 for travel between the customer's location and the dealer, manufacturer, service agent, etc. A mapping program such as Map Quest™ or other similar technology may generate the map 312. The customer record 310 may also include product information 314 that describes the manufactured product or products that have been purchased by the customer. The product information 314 may include a product description, serial number, manufacturing date, and/or any other data associated with the product.

Whenever a need arises for servicing a product, a service call 320 is generated. A service call 320 may include a problem description 321, which describes the type of servicing required and/or the particular problem being experienced with the manufactured product. Each service call 320 can also include a parts list 322 based on the product information 314 in the customer record 310, and which may be retrieved automatically. The parts list 322 may be tailored based on the problem description 321. For instance, if a problem description 321 relates only to a small portion of the product, then the parts list can be tailored only to that small portion.

In one implementation, the service center 201 can check the required parts list 322 against a parts inventory list, and automatically execute a parts order fulfillment program 323 if there are any required parts that are not readily available in the inventory. The parts order fulfillment program 323 can also open a communication channel with a vender associated with any parts that may be required. The service center 201 is also configured to execute a paperwork generation program 325 to automatically generate paperwork related to, and based at least in part on information in, the service call request 330. The paperwork can be an electronic or softcopy version of paperwork, or a hardcopy of paperwork such as invoices, mailing labels, instructions, etc.

The service call 320 can be associated with an information field by which it is designated as “open” (those service calls which have been designated but not yet assigned to a service operator or technician), “assigned,” or “completed” (those service calls that have been completed from the customer's perspective but still require final review and submittal to the manufacturer or dealer). However, the service calls 320 may be designated in other ways, according to a service department's specific requirements. The service call 320 and the customer record 310 are illustrated as linked by a bi-directional arrow to indicate the associative and integrated nature of these outputs depending upon a particular implementation. Accordingly, this description is not to be limiting in any way as to the exact composition and arrangement of information by the service system.

Once all of the information is obtained for the customer record 310 and the service call 320, a service call request 330 may be created. The service call request 330 represents a service call that includes sufficient information to allow it to be assigned to a service operator. One or more service call requests 330 may be grouped into a service route 340 for a particular service operator. The service route 340 may include driving directions for each service call based on the customer map 312 or directions 313, product and/or problem details, parts lists, etc. The service route 340 also may be linked with one or more diagnostic routines 341 or other tools 342 that may be used for a service call based on the service required. Those tools 342 may include diagrams, schematics, test software, parts tracking software, etc. The service route 340 and associated information is downloaded from the database 202 to a hand held device 208. The diagnostic routines 341 and/or tools 342 may be selected for each service call from memory in the hand held device 208 or from the service center 201.

For each service call request 330 in the service route 340, the service operator generates a service call report 350. The service call report 350 includes a list of parts consumed 351 during servicing, results of diagnostics and/or tests 352, and other data 353. The other data 353 may include, for example, one or more images captured by a digital camera attached to the hand held device 208, audio captured by a microphone coupled with the hand held device, or text input by the service operator. The other data 353 can also represent inputs and modifications to the customer record 310 and/or service call 320 made by the service operator for each service call request 330.

The service call report 350 may be uploaded to the service center 201 for generating a completion report 360 that describes the disposition and status of the service. This data can be linked to the customer record 310 and/or service call 320 in order to modify the information therein. For instance, the parts consumed 351 may be used by the automatic parts ordering program 323 to re-stock parts used during a service call, or to reallocate unused parts to another service call. Thus, the service system 200 described above handles all aspects for providing service for a product. At any time proximate to generating a completion report 360, the service center 201 determines a status of a warranty on the product that has been, or is scheduled to be, serviced with a warranty/payment program 355. If a valid warranty exists, and if allowed, the service center 201 executes the warranty/payment program 355 to automatically pay for services according to the warranty.

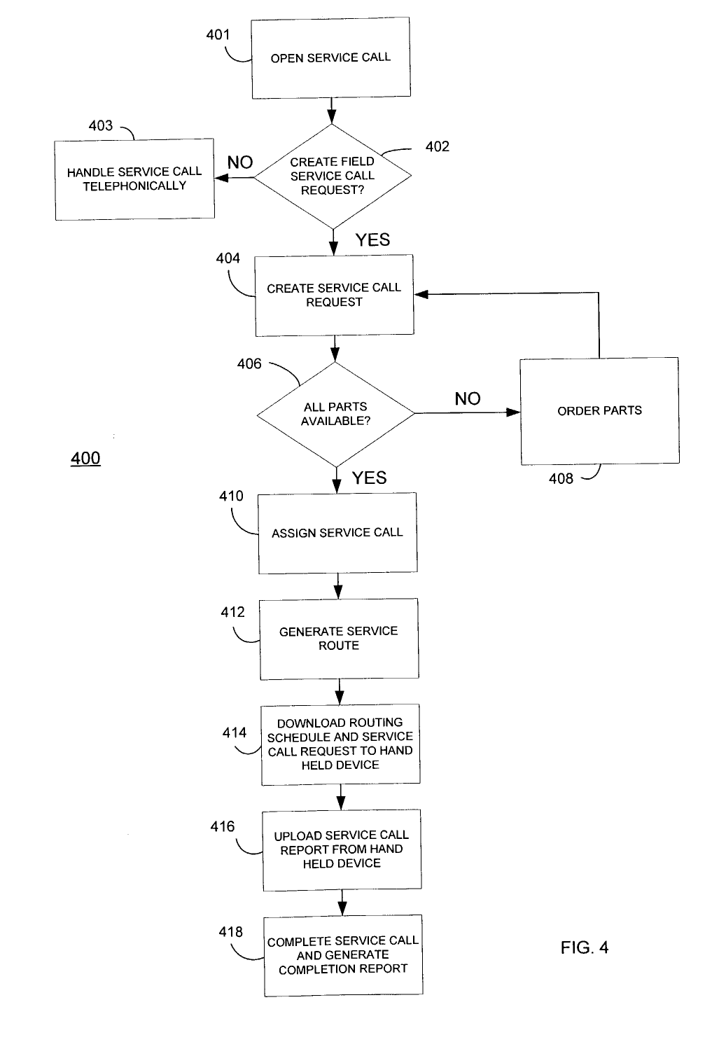

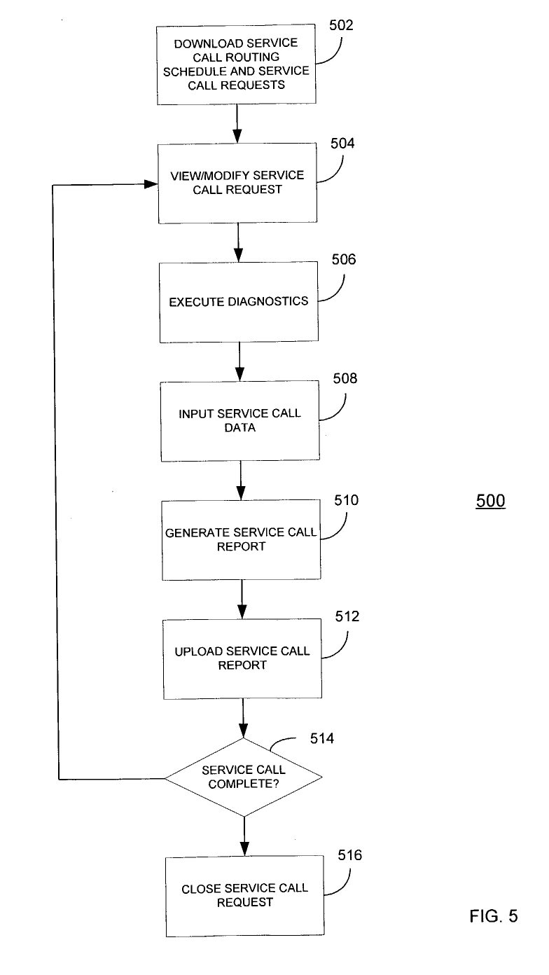

FIGS. 4 and 5 illustrate methods of providing service for a product. FIG. 4 shows one method 400 using a service system as described above. At 401, a service call is opened; i.e., a description of a problem or requested service is input into a terminal and associated with a customer record in a database. The service call may be tagged as opened and unassigned. At 402, a decision is made whether a service call request should be created, i.e. service factors such as the nature of the problem, extent of parts possibly affected, etc., are considered. If possible, a service call request is not created at 403 the service problem is handled by a technician or other qualified person telephonically or by other remote means. If necessary, at 404 a service call request is created in which a parts list to be used for the servicing is generated according to product information in the database and/or the service call information.

At 406, a determination is made whether all needed parts are currently available and/or accessible for being able to carry out the servicing. If not, at 408, an automatic parts ordering program may be executed. In one implementation of 408, parts serial numbers are associated with a parts description of the product to ascertain what parts are needed. Then a check is made against a database of available inventory. If the required type or number of parts is not available, the program orders them from the manufacturer or supplier via a network such as the internet. In another embodiment, a parts list may be decremented corresponding to any parts consumed during servicing. A user may opt to have the decremented parts list automatically trigger a reordering of those parts.

Once the required parts are determined to be available, a service call request will be assigned to a service operator at 410. One or more service call requests may be grouped together in a service route at 412. This grouping may be based on any criteria such as common geographic area, available time slot, type of product(s), nature of service required, and/or service technician, etc. At 414, the service route and associated information is formatted and downloaded to a hand held device, which is used by the service operator to execute the service. At 416, the service center uploads a service call report from the hand held device. Each service call report is linked to a service call request so that information in the database can be changed to reflect the status or result of the service call. This service call report can also be used to generate a completion report, which is accessible via network by the manufacturer or other reviewing entity.

FIG. 5 illustrates a method 500 of managing a service call from a hand held device in communication with a networked database. At 502, the hand held device downloads information associated with a service call from a database, including a service call request that has been assigned to the service operator associated with the hand held device. The information may be specially formatted for the particular type of hand held device. The service operator can view and/or modify the information contained in the service call request at 504. For instance, the information can be provided in a series of screen displays that are navigable by operation of a scroll button or key on the hand held device. Alternatively, the information may be provided in a user interface for the receipt of data to be added to or replace information in the hand held device. The downloaded service call request can include one or more diagnostic routines or other tools as described above, or associated with diagnostic routines and tools pre-stored in the hand held device and associated by logic in software or hardware.

At 506 the service operator executes the diagnostic routines and/or employs any useful tools using the hand held device, which receives and tracks the results either automatically or by manual input. At 508, other data such as text, photographs, or audio files may be input into memory of the hand held device and linked to the servicing. At 510, the hand held device is used to generate a service call report, which can represent the service call request as modified with results of the service and any new data or information. The service call report is uploaded to the service center at 512.

At 514, a determination can be made whether the service call has been completed. If the service call has not been completed, the service call request can be accessed and modified by the service operator to indicate that further servicing is required. If complete, the service call request is closed based on the service call report. Those having skill in the art would recognize that the steps of the methods just described above can be interchanged without departing from the scope of the invention, and that the above description is illustrative only.

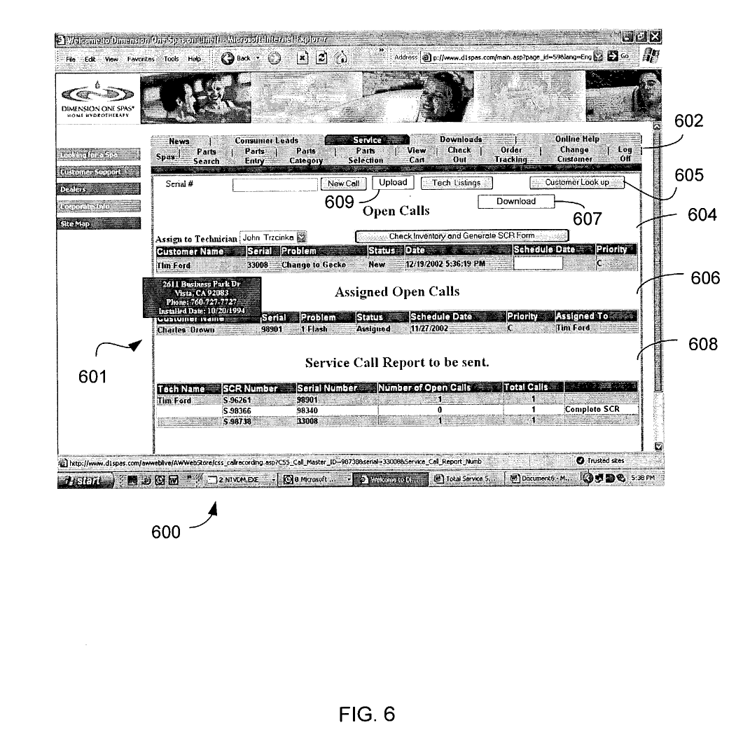

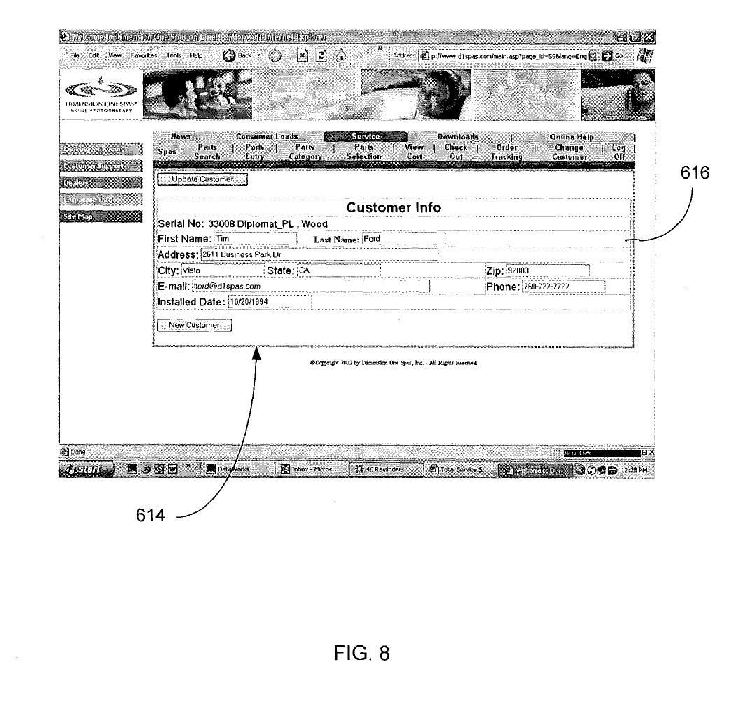

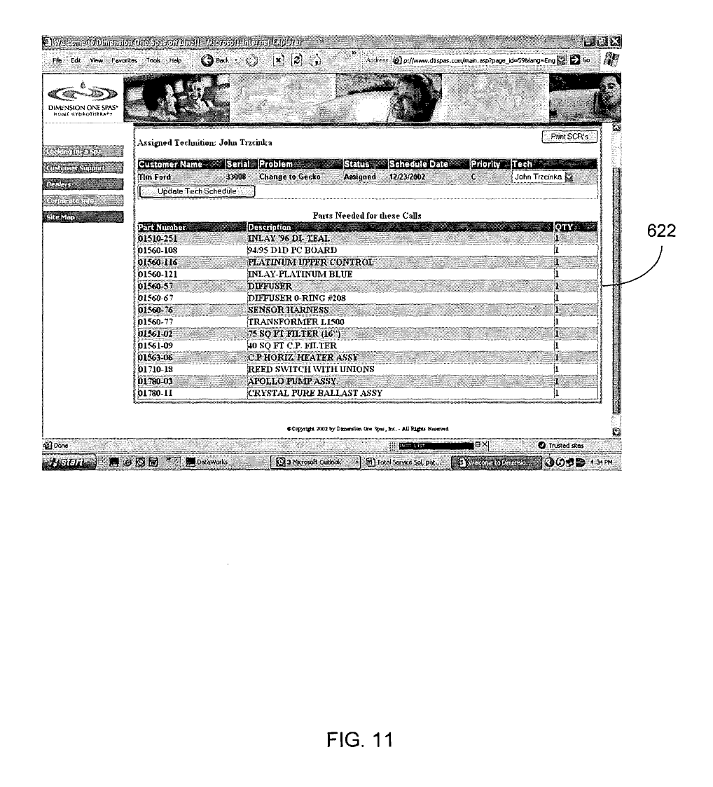

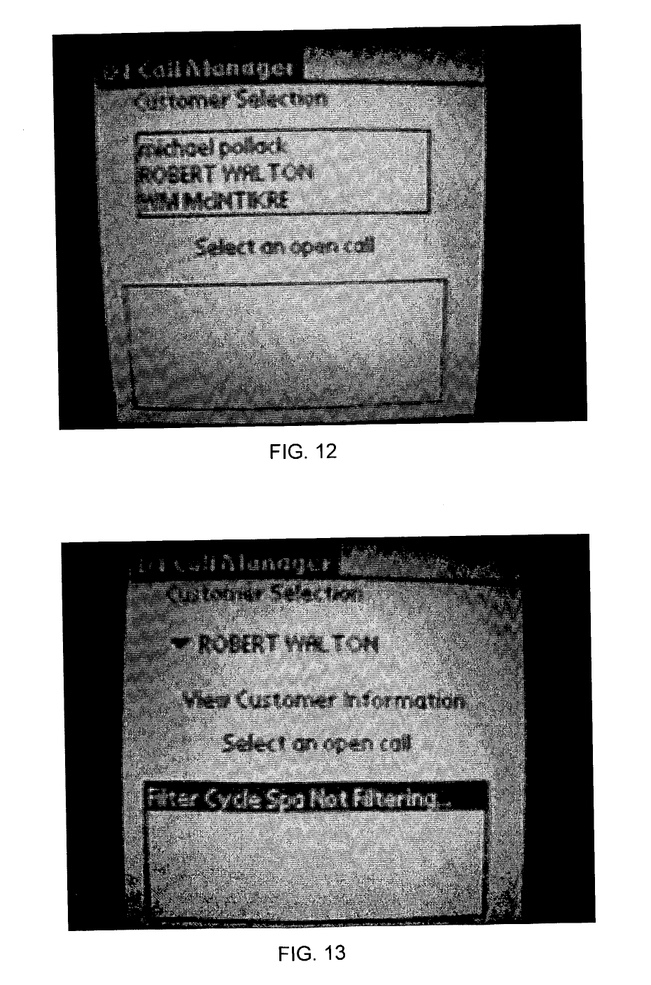

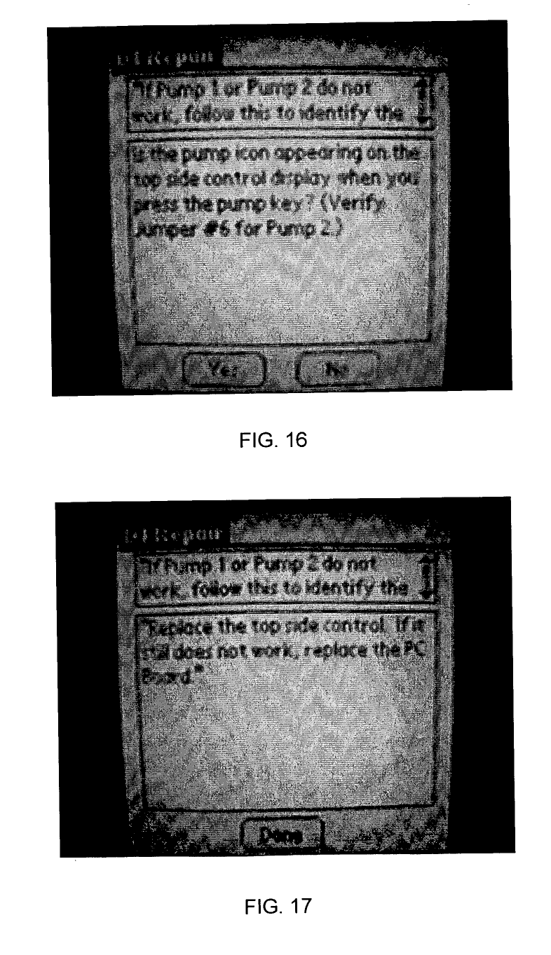

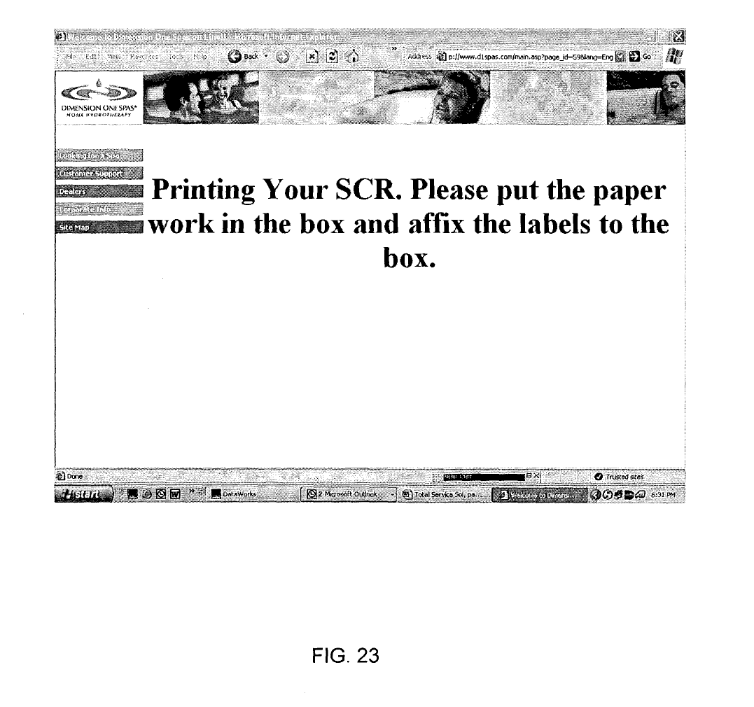

A service system and method particularly suited for the pool/spa industry will now be described. FIGS. 6-11 and 20-23 show screen shots of a display at a service center terminal, and FIGS. 12-19 show screen shots of a user interface of a hand held device, for servicing various models of spas.

A service call can be created for a customer upon receipt of an e-mail alert by the service center of service related information. The e-mail alert may include a link to a service home web page 600. FIG. 6 shows an example of the service home web page 600 in a browser application being executed on the service center terminal. The service home web page 600 can be accessed by a login and/or password for secure web-based access to enter, view and/or modify existing customer records within parameters provided by the manufacturer, or to add or delete customer records as needed. The service home web page 600 includes a main menu window 601 that provides a navigation bar 602 for navigation to various related web pages or windows within or outside the secure area corresponding to the service home web page 600.

In one particular implementation, information is categorized into three areas (or subwindow) of the main menu window: Open Service Calls 604 (service calls requiring service for which a service call request has not yet been generated), Assigned Open Calls 606, and Service Call Report to be Sent 608 (service calls for which a service call report has been generated, but which still require final review or submittal to the manufacturer). Detailed customer and product information are readily available by simply dragging a pointing device over a summary data field, or by selecting a navigation tab such as the Customer Look Up tab 605. Upon locating the appropriate customer via either a look up option or the entry of a valid serial number for the product, a user may have the option to modify the existing customer information or attach a new customer number to a serial number, thus retaining a “history” a the product.

Within the web page, a download tab 607 can be used to download customer information to a text file, such as a text delimited file (TDF), for text-based functions such as mass mailings, information exchange with external databases, etc. An upload tab 609 can be used to upload third party or other external customer information into the service database.

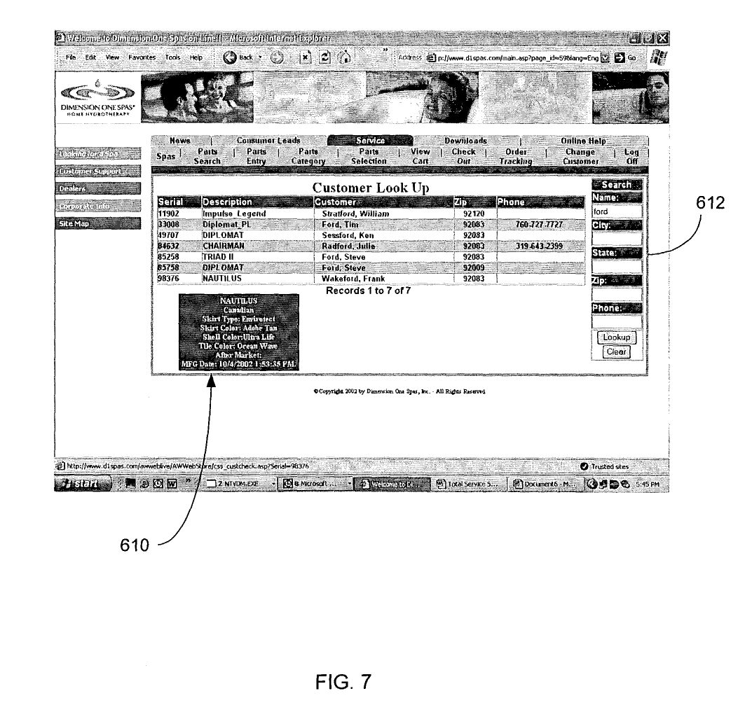

FIG. 7 shows the Customer Look Up window 610 that is accessed by selecting the Customer Look Up tab 605 in the main menu. The Customer Look Up window 610 can include a list of customers, a serial number of a spa owned by each customer, a description of the spa, customer location information, and a telephone number for each customer. The Customer Look Up window 610 may also include a search window 612 into which any of a variety of search terms may be entered for searching for information about customers and/or products. Upon selection of any parameter associated with a customer in the Customer Look Up window 610, a Customer Info window 614 is provided which includes a customer file 616 with detailed customer information as shown. The customer file 616 has a number of data input fields as shown. The Customer Info window 616 can also provide navigable tabs for updating customer information or accessing a new customer file 616.

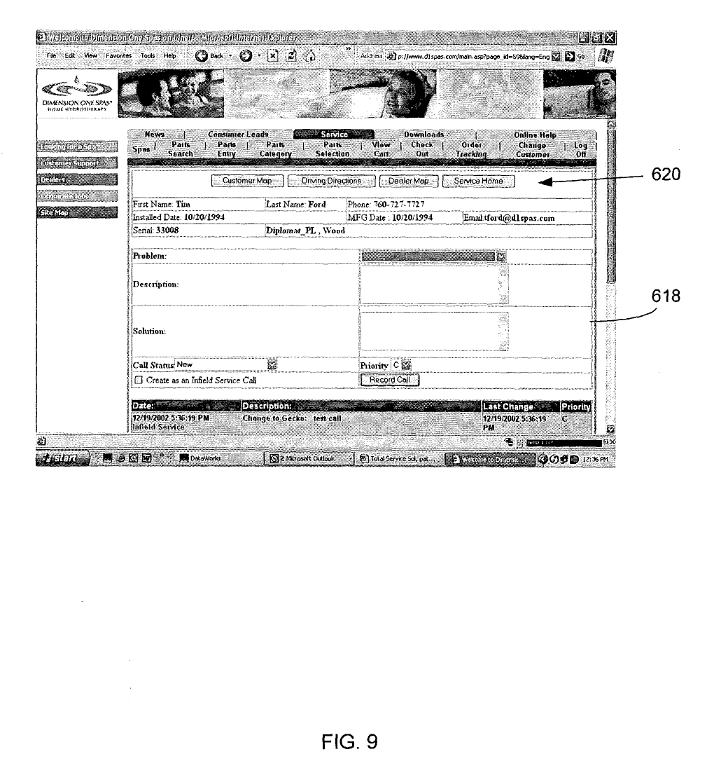

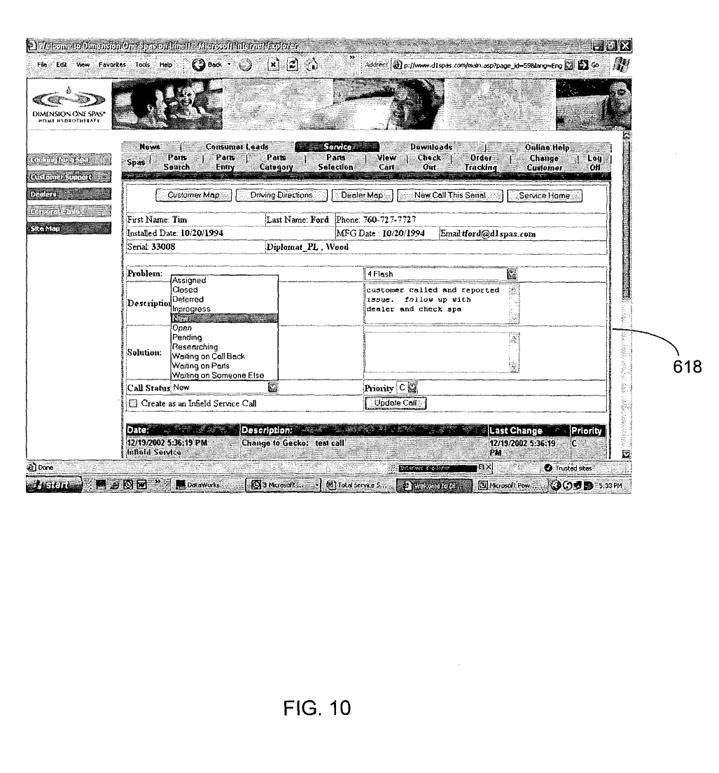

A user can select a navigation tab in the Customer Info window 614 to access a Detailed Customer Information window 618, shown in FIGS. 9 and 10. The Detailed Customer Information window 618 can include one or more function tabs 620 that execute a function such as generating a customer map, driving directions between the customer location and the service agent/dealer, or to access the service center home page 600. As illustrated more clearly in FIG. 10, the Detailed Customer Information window 618 can also include data entry fields for receiving a problem description and/or solution, for assigning a status to a service call, and for setting a priority to a problem/service call.

By selecting a particular tab on the navigation bar 602, a user can access a parts list 622 associated with a service call and/or customer record. The parts list 622 can be a list of parts needed for a particular service call, a parts list for an entire spa product or portions thereof, or a list of parts that require replacement or ordering. The parts list 622 can include a part number, a part description, and/or a quantity of the part that is required for the particular situation.

The parts list enables ordering parts dynamically from the vendor, without manual intervention by a service system user. The terminal prompts the database to display spa parts information associated with service call requirements. The service home web page is linked to an automatic fulfillment program, which associates specific components, that make up a spa product to a unique serial number, so that part shortages can be “linked” to an on-line storefront for automatic ordering. This functionality enables the service organization/dealer to more likely complete the service call the first time due to available parts. Once the service call has a scheduled date the service organization/dealer can automatically print a number of Service Call Requests. One of these can be sent electronically to the customer, the manufacturer or dealer can retain another. The software also generates a stocking report used to “prep” the truck that will be used by a service operator.

Once schedules have been set, a Service Route is generated for all service calls for a service operator within an established period of time, preferably one day. Once the Service Route has been established, the service operator can print the necessary documents, such as: two Service Call Requests (one for the customer and one for dealer retention) and a map with driving directions from one customer to the next (established from the Service Route). This capability can be augmented with GPS triangulation using customer locations and map databases. A hard copy of this information can be provided, as well as converted into Adobe Postscript Datafile (PDF) format.

The service call request information, including customer information, map, driving instructions to the customer's location, reported problems and/or required services, parts list(s), and diagnostic guides and tools are synchronized with and/or downloaded to a hand held device. In one embodiment, the hand held device uses the Palm Operating Software (Palm OS) or Microsoft Pocket PC OS (Microsoft PPC), to which the service center terminal interfaces using Palm Appforge, Conduit or Microsoft Visual Basic Embedded software, respectively. The Palm OS or Microsoft PPC allows the hand held device to provide interactive screens that allow a user to view and/or modify customer information, customer site directions, reported call information, resolution of a service call, the parts required or consumed, diagnostics, etc. FIGS. 12-19 provide examples of some interactive screens.

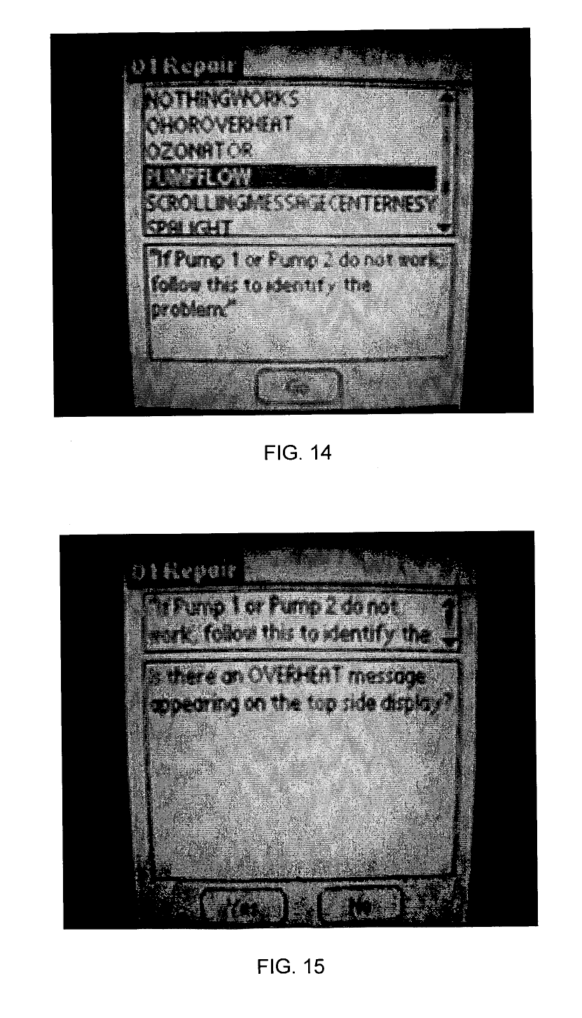

As shown in FIG. 12, the hand held device displays a list of customers on a service route. The service operator can select a customer (FIG. 13) to view contact information such as address and phone numbers, maps and driving directions, and the general nature of the required service, scrolling on the interactive screen where necessary. The service system database is dynamic and can be easily modified via text file. Accordingly, each time a download is made to a hand held device, new files are downloaded to provide the latest information for customers. FIG. 14 shows a list of issues that may be applicable to one customer's particular issue, with a description of the latest known resolution steps.

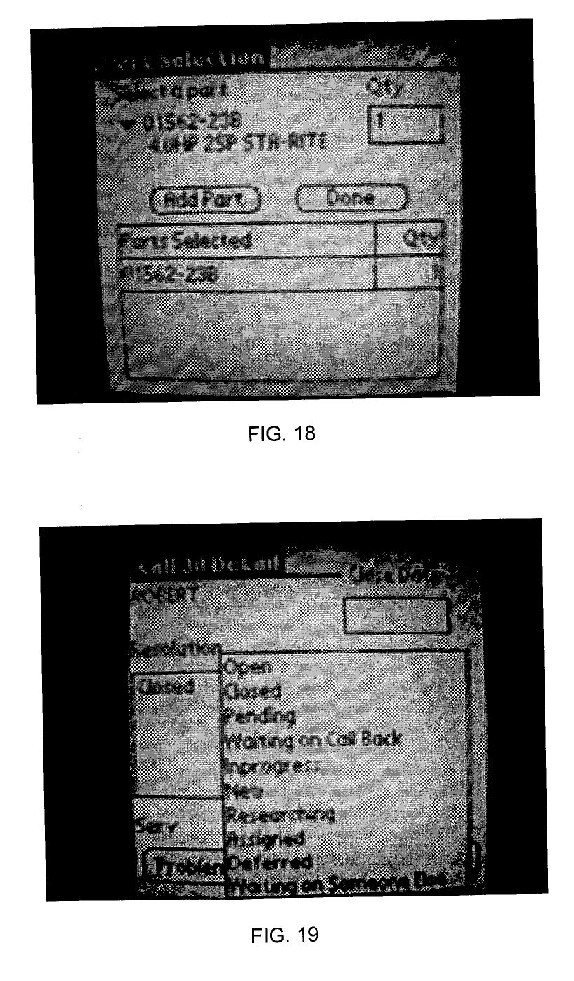

Once a diagnostic routine is selected and executed, the operator can follow a simple “yes/no” navigation theme to quickly and easily diagnose the problem, as shown in FIGS. 15-17. Drop-down menus can display lists of information, such as, for instance, spa parts consumed during a service call as shown in FIG. 18. Other lists include parts needed for repairs, all parts that make up a particular spa model or part, etc. The parts are associated based on a serial number of a top-level part. These lists are also downloaded to the hand held device at the time of synchronization with the service center terminal. FIG. 19 illustrates a display of service call disposition/resolution options that can be selected by the service operator. These options will be used to create the service call report. The hand held device may also be used to record images or sound files associated with the service. The disposition/resolution information and other files can be uploaded to the database via the manufacturer's/dealer's web portal using Palm Appforge, Microsoft Visual Basic Embedded, and/or Conduit programs. Upload is also possible via a cradle to the terminal, or by wireless communication from the hand held device to the terminal and database.

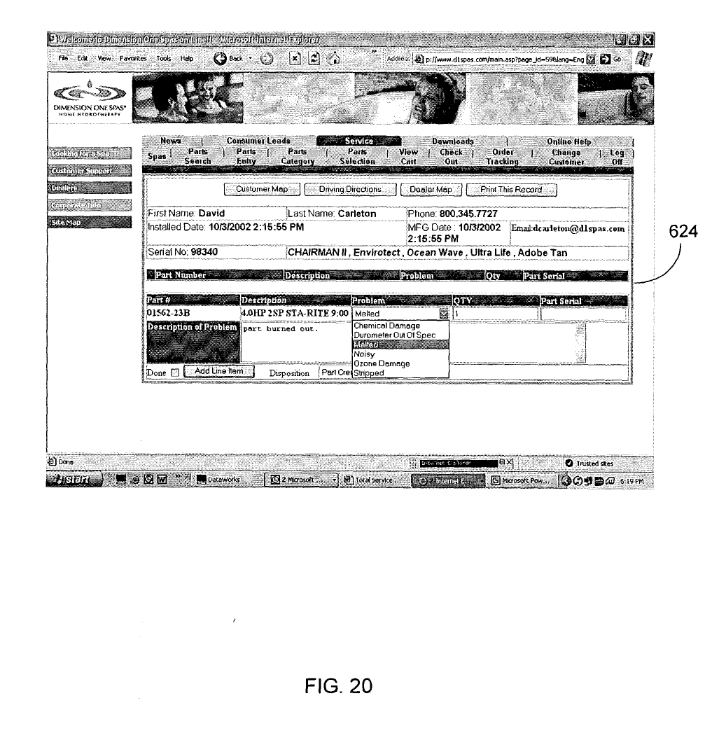

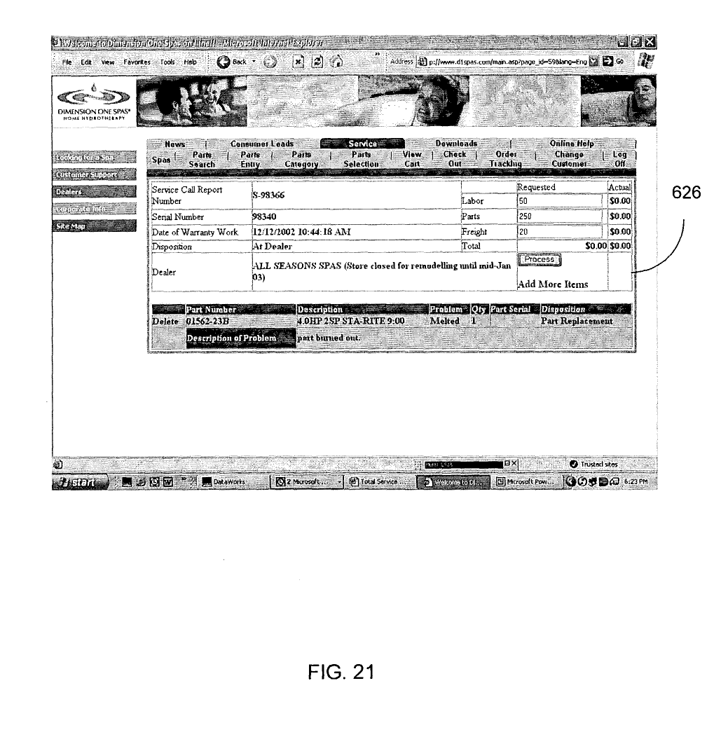

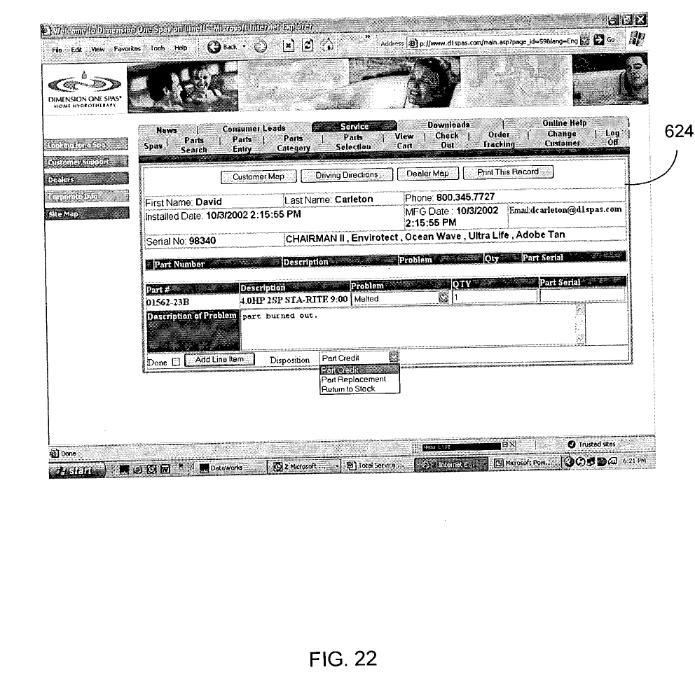

FIG. 20 shows an example of a web page displaying a revised customer file 624 after receiving uploaded information from the hand held device. The revised customer file 624 includes updated fields describing the nature of service such as a problem description, a list of parts consumed during service, and other information about the service. For example, the database can track warranty information for each part in a spa delivered to a customer, and determine whether the services rendered were covered by the warranty. The information now included in the revised customer file 624 can then be used to generate an invoice 626 for the supplier, manufacturer, or dealer, as shown in FIG. 21, as well as a final disposition of the service as shown in FIG. 22. The invoice 626 can be generated by any known financial services software, and can be sent electronically to the proper intended recipient for payment of services rendered.

The revised customer file 624 can also be used to generate/print a service call report and shipping labels via a scripting program such as Mead ScriptX. The service call report and shipping labels can be used for the return of defective, replaced and/or unused parts to the manufacturer.

A number of embodiments of the invention have been described. Nevertheless, it will be understood that various modifications may be made without departing from the spirit and scope of the invention. Accordingly, other embodiments are within the scope of the following claims.

What is claimed is:

1. A method for providing service for a product, comprising:
associating service call information with a customer record, wherein the customer record includes product information, to generate a service call request;
grouping one or more service call requests into a service route; and
downloading the service route to a hand held device.

2. The method of claim 1, wherein associating service call information with the customer record further includes providing a map of a customer's geographic location.

3. The method of claim 2, wherein grouping one or more service call requests into a service route is based on the customer's geographic location.

4. The method of claim 2, wherein associating service call information with the customer record further includes providing driving directions to the customer's geographic location.

5. The method of claim 1, wherein associating service call information with the customer record further includes providing a parts list for the product information.

6. The method of claim 5, further comprising generating a list of required parts based on the product information and the service call information.

7. The method of claim 6, further comprising determining whether the required parts are available.

8. The method of claim 7, further comprising, if all of the required parts are not available, automatically ordering unavailable parts.

9. The method of claim 1, further comprising uploading results of a server call request from the hand held device.

10. The method of claim 1, further comprising:
opening the service call request with a vendor by forming a communication channel with the vendor according to the service call request; and
closing the service call request with the vendor upon completion of the associated service call.

11. A method for providing service for a product, comprising:
downloading a service route from a database to a hand held device, the service route including a grouping of one or more service call requests, and wherein each service call request includes service call information associated with a customer record, and wherein each customer record includes product information; and
associating one or more diagnostic routines to each service call request.

12. The method of claim 11, wherein associating one or more diagnostic routines is based on the service call information.

13. The method of claim 11, wherein associating one or more diagnostic routines is based on the product information.

14. The method of claim 11, further comprising modifying at least one service call request.

15. The method of claim 14, wherein modifying at least one service call request further includes appending a digital photograph to the service call request.

16. The method of claim 14, wherein modifying at least one service call request further includes receiving text.

17. The method of claim 14, wherein modifying at least one service call request further includes changing a status of the service call information.

18. The method of claim 11, further comprising:
executing the one or more diagnostic routines; and
receiving an indication of a result of each diagnostic routine.

19. The method of claim 11, further comprising:
modifying at least one service call request to generate a service call report; and
uploading the service call report to the database.

20. The method of claim 19, further comprising appending a digital photograph to the service call report.

21. The method of claim 19, further comprising inputting to the service call report.

22. A system for providing service for a product, comprising:
a terminal for receiving and processing service call information;
a database for associating the service call information with a customer record, wherein customer record includes product information and customer history, to generate a service call request; and
a hand-held device configured to receive the service call request from the database.

23. A system for servicing one or more spas at one or more customer locations, comprising:
a database storing product information and customer information, wherein the product information includes a parts list for each of the one or more spas, and wherein the customer information includes a map and directions to each of the one or more customer locations;
a terminal, in communication with the database, having a web browser for providing an interactive display of the product information and customer information, and being configured to generate a service call request for servicing at least one of the one or more spas; and
a hand held device configured to receive the service call request from the database.

24. A method for servicing one or more spas at one or more customer locations, comprising:
maintaining a database of information about each of the one or more spas, the information including customer information and a parts list of each spa;
associating a problem description with one of spas to generate a service call request; and
generating a list of parts and at least one diagnostic routine required to fulfill the service call request.

25. The method of claim 24, further comprising:
accumulating one or more service call requests to form a service route; and
downloading the service route to a hand held device.

26. The method of claim 24, further comprising:
determining whether a parts inventory corresponds to the list of parts; and
automatically ordering any parts from the list of parts that are not available in the parts inventory.

27. The method of claim 25, further comprising:
executing the at least one diagnostic routine; and
generating a service call report based on results of the at least one diagnostic routine.

28. A method for providing service for a product, comprising:
associating service call information with a customer record, wherein the customer record includes product information, to generate a service call request;
downloading the call request to a hand held device;
reporting a status of the service call request to a vendor according to the service call request;
closing the service call request with the vendor upon completion of a service call associated with the service call request.

29. The method of claim 28, further comprising invoking a paperwork generation program on a central terminal, wherein the paperwork generation routing is configured to generate paperwork related to the service call request.

30. The method of claim 29, wherein the paperwork includes mailing labels for return packaging for a product part associated with the service call request.

31. The method of claim 28, further comprising invoking a parts replenishment program on a central terminal, wherein the parts replenishment program is configured to order parts related to the service call request.

32. The method of claim 31, wherein the parts replenishment program is configured to open a communication channel with the vendor.

33. The method of claim 28, further comprising:
determining a status of a warranty on the product; and
if allowed under the status of the warranty, providing automatic payment of services rendered under the service call request.
